(19) United States
(12) Patent Application Publication
(10) Pub. No.: US 2011/0290926 A1
(43) Pub. Date: Dec. 1, 2011

(54) ADAPTABLE MULTI-GRATER SET

(75) Inventor: Murat Kolbasi TALIP, Eyup-Istanbul (TR)

(73) Assignee: ARZUM ELEKTRIKLI EV ALETLERI SANAYI VE TICARET ANONIM SIRKETI, Eyup-Istanbul (TR)

(21) Appl. No.: 13/029,371

(22) Filed: Feb. 17, 2011

(30) Foreign Application Priority Data
Jun. 1, 2010 (TR) 2010/04365

(51) Int. Cl. A47J 43/25

(52) U.S. Cl. 241/273.4; 241/95; 241/168

(57) ABSTRACT

An adaptable multi-grater set has a special wing configuration that allows it to be attached on different bowls and stewpots. The multi-grater set has side-accessories, such as the wings which can be put on an axis, a scale part, mini bowls, and different grater blades/slicers which can be fixed on the wings.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The invention is related with to an adaptable multi-grater set.

2. Description of Related Art Including Information Disclosed Under 37 CFR 1.97 and 37 CFR 1.98

Conventional Products

The main feature of an adaptable multi-grater set is its adaptability on bowls and stewpots regardless of their form and dimensions. This feature offers a practical and fast use of grating action, allowing the user to grate the related ingredient right into the bowl or stewpot without sullying another bowl or plate.

There are some conventional graters on the market that can be attached on scaled mini-bowls. But the user should wash the scaled bowl in between the different ingredients. In an adaptable multi-grater set the scale part and mini-bowl part are separated. This has two advantages: the mini-bowls can be used on serving purposes; and different ingredients can be grated on multiple mini-bowls.

The conventional graters with scaled bowls allow only perpendicular grating, but an angled holding position of the grater is more ergonomic. The adaptable multi-grater set mini-bowls bottom surface design allows the user to grate at angled positions.

The Objective

The purpose of this product is to develop a new grater, which offers a more ergonomic, practical and efficient grating action, allowing the user to work in an organized way with multiple grated ingredients during cooking

Its adaptability on different bowls and stewpots offers a practical use in urgent grating actions. This also causes in sullying less bowls or plates, resulting in less sullied dishes, resulting in less dish water usage.

The conventional multi-graters on the market have disadvantages related to cleaning issues. The adaptable multi-grater set accomplishes an easy to clean design with its detachable wings and grater/slicer blades.

Considering the amount of repeated arm movements and associated fatigue, the ergonomic issues are vital in a grater design. The wing of the adaptable multi-grater set and angled usage offer a more ergonomic grating action than the conventional graters on the market.

### BRIEF SUMMARY OF THE INVENTION

The present invention is an adaptable Multi-Grater Set characterized in that it has a special wing configuration that allows it to be attached on different bowls and stewpots. It has side-accessories, such as the wings (1, 2) which can be put on an axis (1c, 2c); a scale part (4), mini bowls (5); and different grader blades/slicers (3) which can be fixed on the wings.

The scale-part (4) fixes the wings (1, 2) of the adaptable multi-grater set so that it can be used on the mini-bowls. It shows the exact amount of grated ingredients. The mininbowls (5) offer an organized way of working with ingredients during cooking Besides, their design allows the user to serve the grated ingredient (chocolate, nuts etc.) right to the table. The wing of the adaptable multi-grater set permits an easy change of various grater blades and slicers for various ingredients (cheese, nuts, carrots etc.).

### BRIEF DESCRIPTION OF THE SEVERAL VIEWS OF THE DRAWINGS

FIG. 1 is a perspective view of the multi-grater set of the present invention showing stand-alone use (grating on the minibowl).

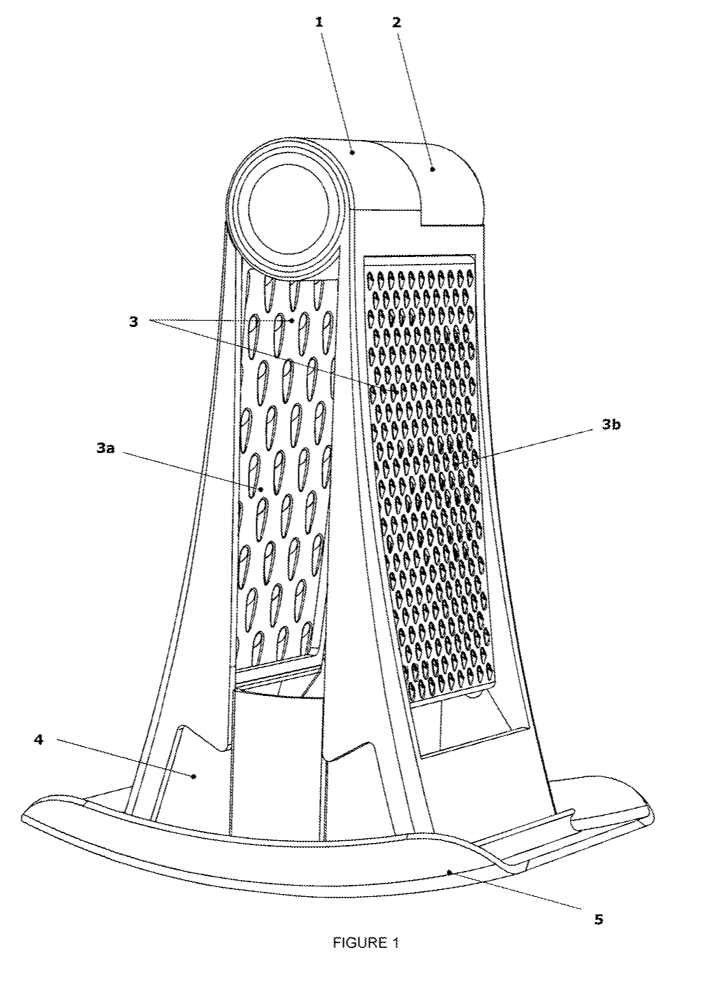

FIG. 2 is a perspective view of the multi-grater set of the present invention showing wing use (grating on any bowl or stewpot using the wing feature).

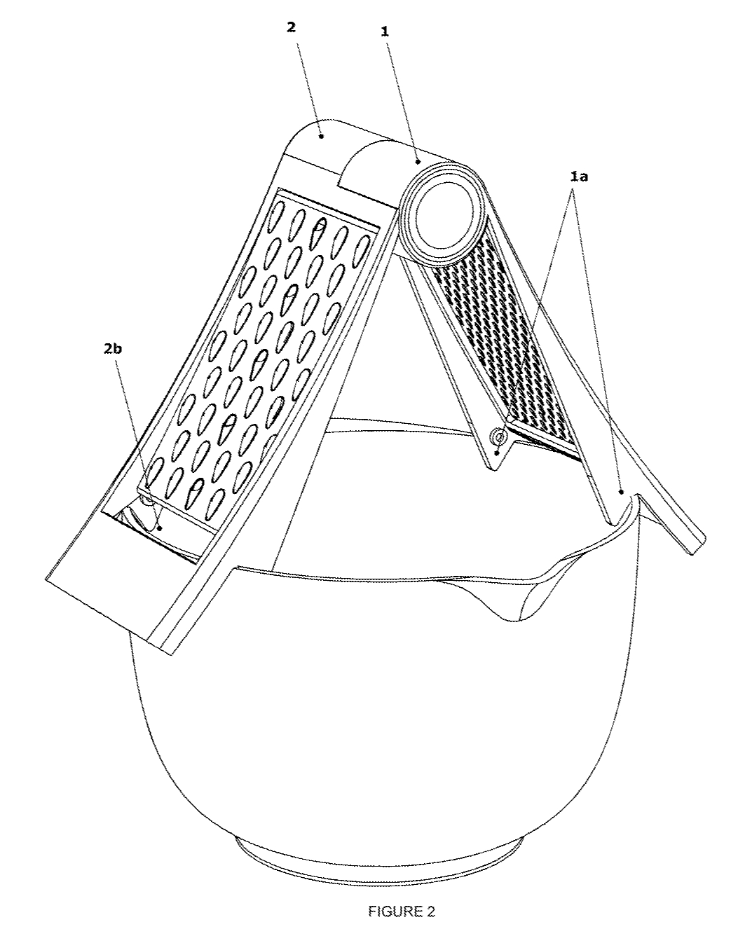

FIG. 3 is an exploded view of the multi-grater set of the present invention.

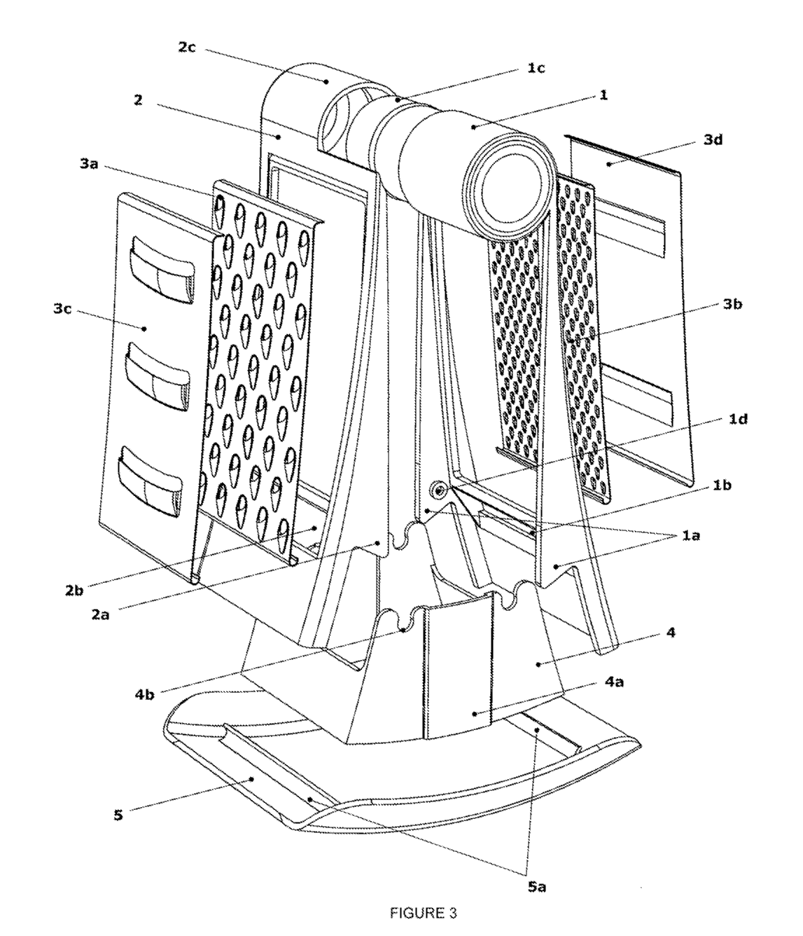

FIG. 4 is a schematic view showing grated pieces during wing use.

FIG. 5 is a schematic view showing various grating angles during stand-alone use

### DESCRIPTION OF THE NUMERALS IN THE FIGURES

(1) Wing#1

(1a) Wing#1 claws

(1b) Wing#1 aperture

(1c) Wing#1 axis rod

(1d) Wing#1 fixture protrusion

(2) Wing#2

(2a) Wing#2 claws

(2b) Wing#2 aperture

(2c) Wing#2 axis burrow

(2d) Wing#2 fixture protrusion

(3) Grater/Slicer Blades

(3a) Blade#1 (coarse grater)

(3b) Blade#2 (fine grater)

(3c) Blade#3 (chips slicer)

(3d) Blade#4 (cheese)

(4) Scale part

(4a) Scale face

(4b) Fixture cuts

(5) Mini-bowl

(5a) Mini-bowl sets

### DETAILED DESCRIPTION OF THE INVENTION

The adaptable multi-grater set includes the following elements: Two wings (1, 2) that are attached on an axis (1c, 2c) and can be opened at a desired angle; grater blades/slicers (3) that are attached on the wings (1, 2); a scale part (4); and mini-bowls (5).

The main feature of the present invention is that it can be used on different bowls and stewpots (wing-use). The wings (1, 2) are attached on an axis by driving the axis rod on wing#1 (1c) into the axis burrow on wing#2 (2c). To use the adaptable multi-grater set on a bowl or stewpot (wing-use) its wings (1, 2) are opened at the necessary angle and put onto the bowl. The wing claws (1a, 2a) catch the edge of the bowl and the adaptable multi-grater set is fixed on the bowl due to the geometry of the wing claws.

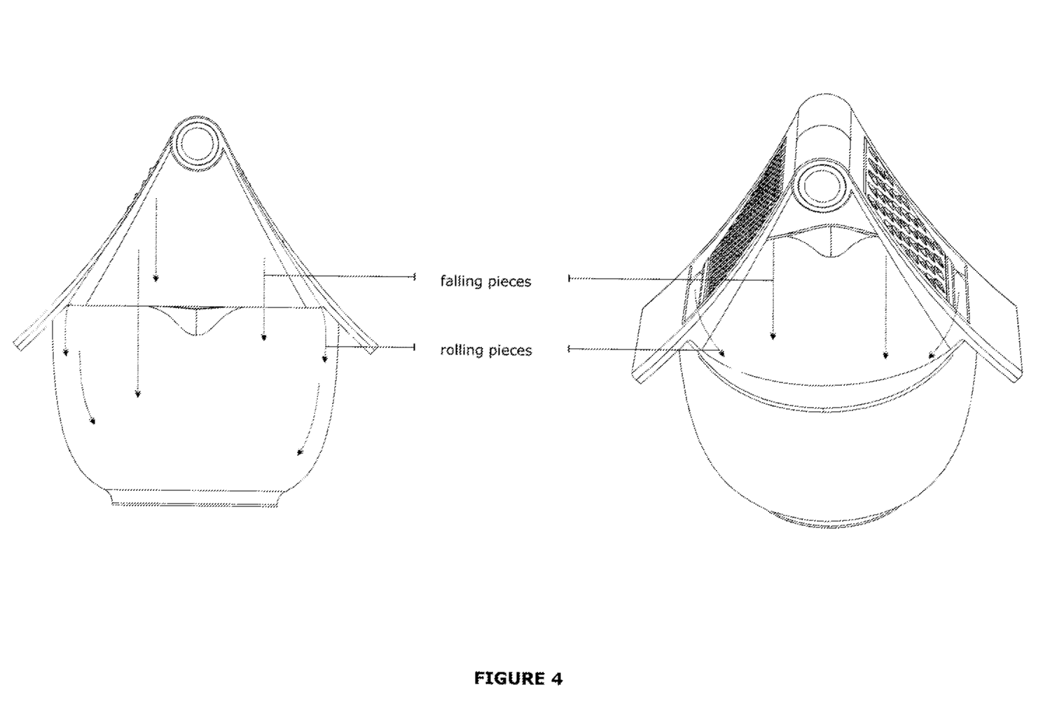

During wing-use, the rolling pieces of the ingredient falls into the bowl/stewpot due to the wing apertures (1b, 2b) (FIG. 4).

Different grater (3a, 3b) and slicer (3c, 3d) blades can be used with the wings. They can be changed both during wing-use and stand-alone use.

The adaptable multi-grater set can be used on its special designed mini-bowls (5) (stand-alone use). For stand-alone use, the scale part (4) is driven between the wings from below. The scale part fixes the wings (1, 2) due to the fixture cuts (4b) on the scale part and fixture protrusions (1d, 2d) on the wings.

The fixed adaptable multi-grater set can be put on the mini-bowl (5) by clicking it in between the sets on the mini-bowl (5a). The amount of the grated ingredient can be read on the scale face (4a).

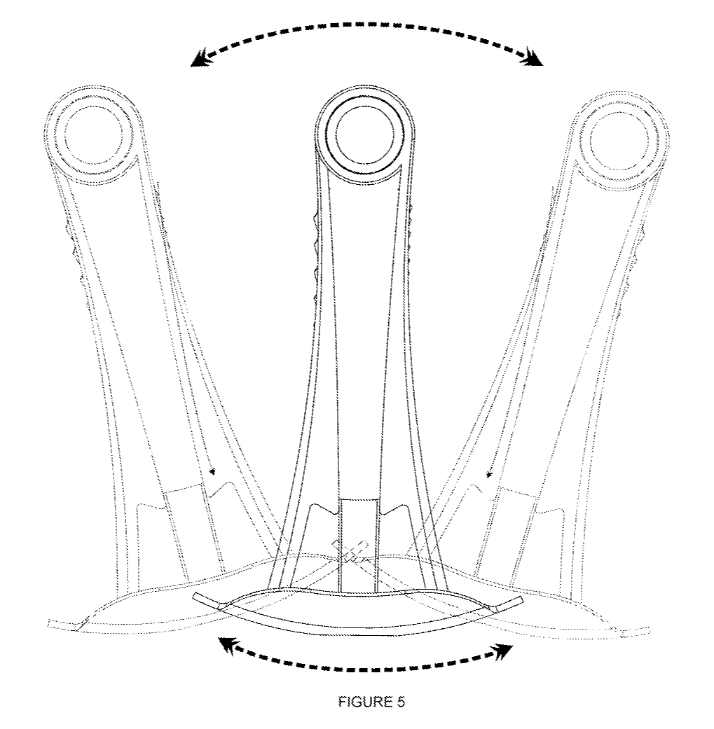

The axis geometry of the wings allows an ergonomic grip on the wings both during wing-use and stand-alone use. The bottom surface geometry of the mini-bowl (5) allows the user to grate at the desired ergonomic angle [FIG. 5].

Operation

Wing Use (using adaptable multi-grater set on any bowl or stewpot): the desired grating/slicer blades (3) are attached on the wings; the wings (1, 2) are opened at the required angle; the adaptable multi-grater set is put onto the bowl/stewpot; the adaptable multi-grater set is pushed down until wing claws (1a, 2a) catch the edge of the bowl/stewpot; and the ingredient can be grated on the desired side by holding the adaptable multi-grater set at the top.

Stand-alone Use (fixing adaptable multi-grater set's wings with the scale part (4) and using it on the mini-bowls (5)): the desired grating/slicer blades (3) are attached onto the wings; the wings are fixed by driving the scale part (4) between the wings from below, until its fixture cuts (4b) click onto the fixture protrusions (1d, 2d) on the wings (1, 2); the fixed adaptable multi-grater set is put on the mini-bowl (5) till it clicks on the mini-bowl sets (5a); the ingredient can be grated on the desired side at the desired angle; and the amount of the grated ingredient can be read on the scale face (4a).

The Advantages of the Adaptable Multi-Grater Set.

The adaptable multi-grater set offers a practical, fast and clean grating on different bowls and stewpots.

Its adaptability on different bowl and stewpots offers a practical use in urgent grating actions. This also causes in sullying less bowls or plates, resulting less sullied dishes, resulting in less dish water usage.

Both during the stand-alone use and wing-use it offers an ergonomic grip and grating angle.

During stand-alone use, the amount of the grated ingredient can be read.

The grated ingredient on the mini-bowls can be served right to the table without pouring them into/onto another bowl or plate.

Different grater and slicer blades can be used with adaptable multi-grater set.

The adaptable multi-grater set is easy to clean with its detachable wings and grater/slicer blades.

1. An adjustable multi-grader set characterized in that it has two wings which allow the adjustable multi-grater set to be used with all kinds of different bowls and stewpots, can be put on an axis a scale part, mini bowls; and different grader blades/slicers which can be fixed on the wings.

2. The adjustable multi-grater set of claim 1, characterized in that the axis bar on a first wing of said two wings is slid inside the axis hole on a second wing of said two wings to fix it on an axis.

3. The adjustable multi-grader set mentioned in claim 1, characterized in that the wings which can be opened in any desired angle are placed on a bowl or stewpot and said grater set is fixed by making the wing claws catch the sides of the bowl/stewpot for using it with a bowl or stewpot.

4. The adjustable multi-grater set of claim 3, characterized in that it has wing apertures which allow that the rolled parts of the materials fall inside the pot.

5. The adjustable multi-grader set mentioned in claim 1, characterized in that it has different graters and slicers which can be used together with the wings and changed.

6. The adjustable multi-grader set mentioned in claim 1, characterized in that the scale part is fixed on the wings by sliding the scale part between the wings from bottom and by means of Wing fixture protrusions on the accessory knifes and the wings.

7. The adjustable multi-grader set mentioned in claim 1, characterized in that it is placed on the mini bowl by clicking it between the sets on the mini bowl to read the graded material amount on the face of the scale.
